(19) United States
(12) Patent Application Publication
(10) Pub. No.: US 2023/0257080 A1
(43) Pub. Date: Aug. 17, 2023

(54) FLOATING SOLAR POWER PLANT

(71) Applicant: Moss Maritime AS, Lysaker (NO)

(72) Inventors: Alexander Minge THØGERSEN, Asker (NO); Audun Arnesen NYHUS, Oslo (NO); Ingrid LOME, Oslo (NO); Ole Petter LAKSHOLM, Langhus (NO)

(73) Assignee: Moss Maritime AS, Lysaker (NO)

(21) Appl. No.: 18/011,674

(22) PCT Filed: May 31, 2021
(86) PCT No.: PCT/EP2021/064522

§ 371 Date: Dec. 20, 2022

(30) Foreign Application Priority Data
Jun. 30, 2020 (NO) 20200763

(51) Int. Cl. B63B 35/44; H02S 20/00

(52) U.S. Cl. CPC B63B 35/44; H02S 20/00; B63B 2035/4453

(57) ABSTRACT

A floating solar power plant (1) comprising a floating carrier module (3), wherein the floating carrier module (3) comprises photovoltaic modules (5) for electric power generation and a floating structure (50) provided with one or more buoyancy elements (9) extending into the water. The floating structure (50) further comprises a flexible means (53, 57, 57a, 57b) providing a change of shape of the floating structure when exposed to external forces, as the floating structure (50) comprises a plurality of interlinked rigid elements (51), wherein the rigid elements (51) are linked together with flexible means comprising flexible joints (53) to form a chain that encloses a center area (55). A method is also disclosed.

### TECHNICAL FIELD

The present invention relates to a floating solar power plant.

### BACKGROUND ART

Within the field of floating PV (photovoltaic) power plants there are many different approaches in the prior art. Some power plants are configured for installation on calm water, such as small ponds or small lakes, while others are designed for waves up to a certain size.

Common for all floating power plants is that they involve a carrier system that floats on the water and that carries the power-generating PV modules.

Some plants use a plurality of rigid carrier modules that are interconnected, making a larger structure that cover a significant area. There is also known a power plant where the PV modules are arranged directly onto a floating membrane, as presented in WO2017209625.

Publication WO2019103609 describes an array of pontoons for carrying photovoltaic modules for electric power production on a water surface. To account for mutual movements due to waves, the pontoons are connected with connection modules that can change length, rotate and bend.

US3974789 presents an array of floating structures that are connected with couplings that allow for mutual movements between the structures.

Thus, the common approach in the prior art is to interconnect the floating modules with connections that allows for not only mutual rotation, but also varying distance between the adjacent modules.

### SUMMARY OF INVENTION

With the present invention there is presented a different approach to account for waves, currents and wind that cause movements and forces in a floating PV power plant.

According to a first aspect of the present invention, there is provided a floating solar power plant comprising a floating carrier module. The floating carrier module comprises photovoltaic modules for electric power generation and a floating structure provided with one or more buoyancy elements extending into the water. The floating structure further comprises a flexible means providing a change of shape of the floating structure when exposed to external forces. Furthermore, the floating structure comprises a plurality of interlinked rigid elements, wherein the rigid elements are linked together with flexible means comprising flexible joints to form a chain that encloses a center area.

The flexible means can be of different types. For instance, the flexible means can have the form of a hinge, a bendable link, or a tensile or compressible component.

The floating solar power plant can further comprise a carrying structure carrying the photovoltaic modules and a flexible connection assembly connecting the carrying structure and the floating structure.

By connecting the carrying structure to the floating structure with a flexible connection assembly, one ensures that the floating structure may change shape while letting the shape of the carrying structure maintain its shape.

In many embodiments, the floating solar power plant will comprise a plurality of floating carrier modules that are interconnected with flexible module links. In such embodiments, the floating structures will be exposed to forces from adjacent floating structures, via the flexible module links. Such forces will be adsorbed by said change of shape of the floating structures. This makes it possible to use flexible module links without the tensile or compressible characteristics that are common in the prior art.

According to some embodiments, there may be provided resilient elongated members that extend across the center area between opposite rigid elements.

The resilient elongated members can advantageously extend between opposite flexible joints.

The rigid elements can be straight beams connected with their end portions to the flexible joints.

The resilient elongated members can for instance be made of flexible lines, such as fiber ropes, steel wires, or stiff elongated members, such as bars or rods.

The flexible connection assembly can have at least three connections, of which at least two connections comprise a first part and a second part. In such embodiments, the first part can be configured to move with respect to the second part of the respective connection. This enables the floating structure to change its shape while remaining connected to the carrying structure.

The carrying structure can preferably have a walkway located below at least some of the photovoltaic (PV) modules. In this manner, access is provided to the PV modules from below. Thus, access is provided without casting shadow on the PV modules. In some embodiments, the walkway can be arranged below the PV modules that are arranged at the center of the carrier module.

The carrying structure can have one or more walkways at a perimeter of the carrying structure. The walkway can be configured to pivot between a horizontal orientation and a non-horizontal orientation. In the horizontal orientation, the walkway exhibits a substantially horizontal upper face for support of personnel, and is directly facing the water surface below it. In the non-horizontal orientation, the walkway is pivoted away from the horizontal mode, leaving the water surface uncovered.

In some embodiments, the resilient elongated members can comprise upper resilient elongated members and lower resilient elongated members, which extend between the interlinked rigid elements and an upper and lower position, respectively, of a vertical member located within the central area.

Such embodiments enable the support of a vertical member at the central area, while maintaining the shape-changing characteristic of the floating structure.

The flexible module link can comprise a first module link part and a second module link part configured to be connected to the first module link part. Furthermore, a pull-in line can be fixed to one of the first and second module link parts. The pull-in line can extend through an aperture of the other of the first and second module link parts. The pull-in line facilitates connecting the floating carrier modules to adjacent floating carrier modules. The pull-in line can be operated with a winch.

Preferably, the first or second module link part can comprise a flexible joint. The first and second module link part can preferably also comprise a guiding means, to facilitate interconnection of the two parts.

According to a second aspect of the invention, there is provided a method of installing a floating solar power plant on a sea surface. The power plant comprises a plurality of carrier modules configured to carry photovoltaic modules. The method comprises the following steps:
a) while floating on the sea surface, connecting a plurality of carrier modules into a first row of carrier modules, by means of flexible module links between the adjacent carrier modules;
b) connecting a plurality of further carrier modules into a second row of carrier modules, by means of flexible module links between adjacent carrier modules;
c) moving, on the sea surface, the first row of carrier modules towards the second row of carrier modules; and then
d) connecting, by means of a flexible module link, one carrier module of the first row to one carrier module of the second row; and then
e) connecting further adjacent carrier modules of the first and second row to each other to form two connected and parallel first and second rows; and then
f) connecting additional rows of carrier modules to one of the previously connected rows of modules.

In some embodiments of the second aspect of the invention, the floating solar power plant can be according to the first aspect of the invention.

Also disclosed herein is a floating wind power plant comprising one or more floating carrier modules. The floating carrier module comprises a wind turbine assembly with a wind turbine arranged on a turbine tower, for electric power generation. The floating carrier module comprises a floating structure provided with one or more buoyancy elements extending into the water. The floating structure comprises a plurality of interlinked rigid elements, wherein the rigid elements are linked together with flexible means comprising flexible joints to form a chain that encloses a center area. The floating structure further comprises resilient elongated members. The resilient elongated members comprise upper resilient elongated members and lower resilient elongated members, which extend between the interlinked rigid elements and an upper and lower position, respectively, of a vertical member located within the central area.

The vertical member can typically be a part of the turbine tower.

### DETAILED DESCRIPTION OF THE INVENTION

While various features of the invention have been presented in general terms above, a more detailed and non-limiting example of embodiment will be presented in the following with reference to the drawings, in which

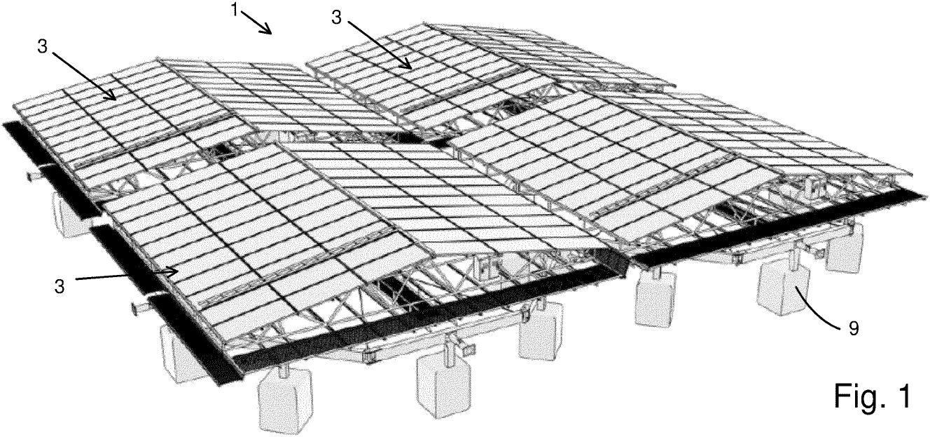

FIG. 1 shows a floating photovoltaic power plant according to the invention, comprising a plurality of interconnected floating carrier modules;

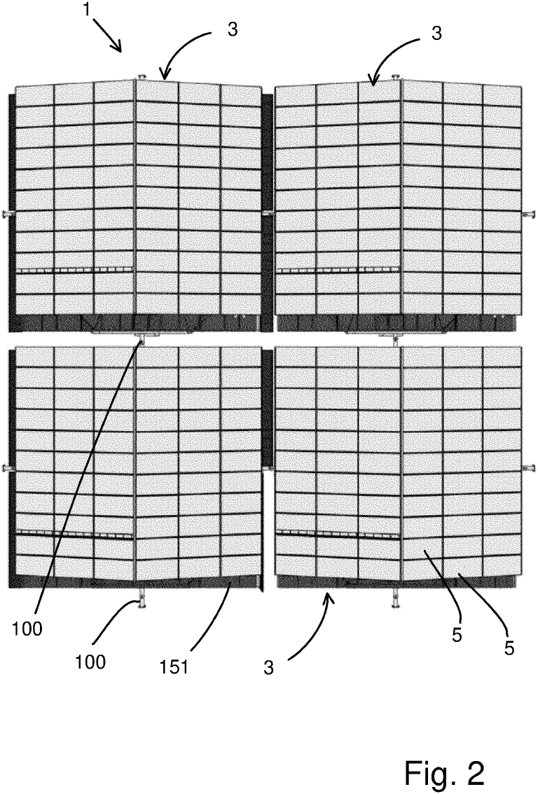

FIG. 2 is a top view of the power plant shown in FIG. 1

FIG. 3 is a perspective view of one carrier module, with the photovoltaic modules removed for illustrational purpose;

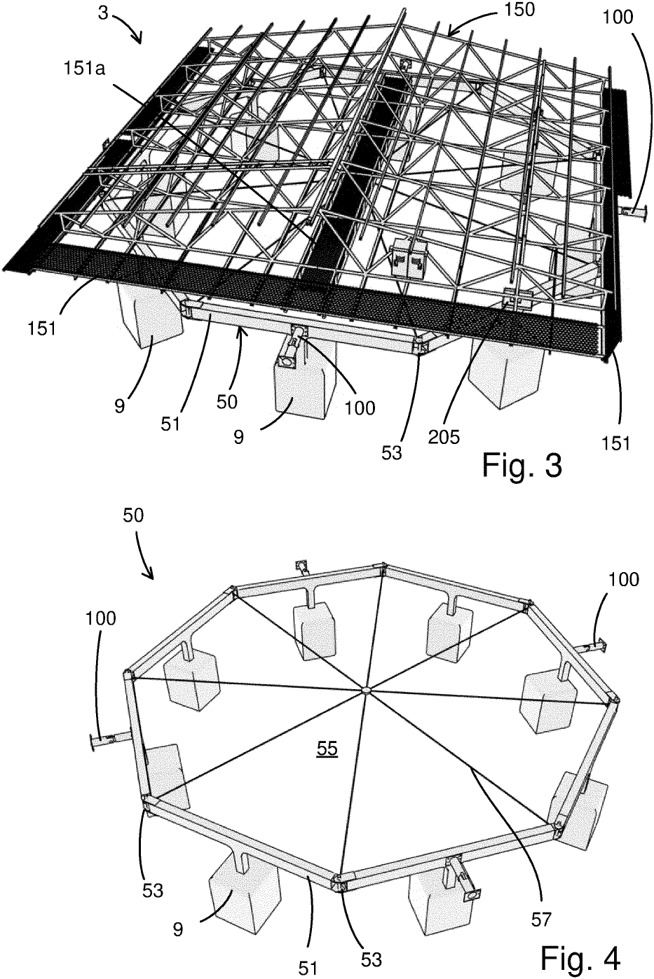

FIG. 4 is a perspective view of a floating structure having a plurality of buoyancy elements configured to extend into a body of water;

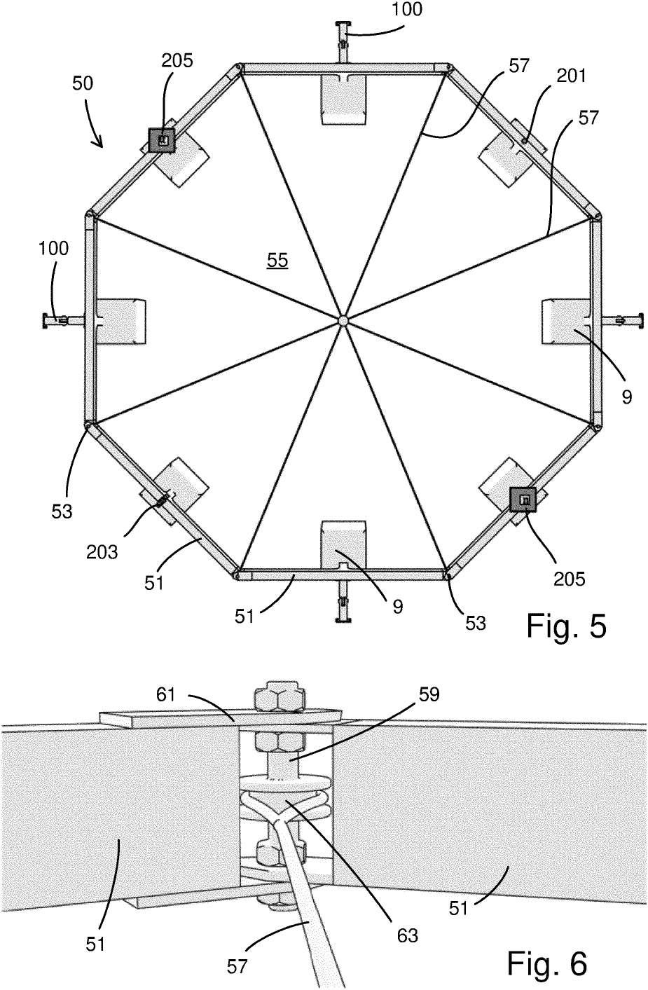

FIG. 5 is a top view of the floating structure shown in FIG. 4;

FIG. 6 is an enlarged perspective view of a part of the floating structure;

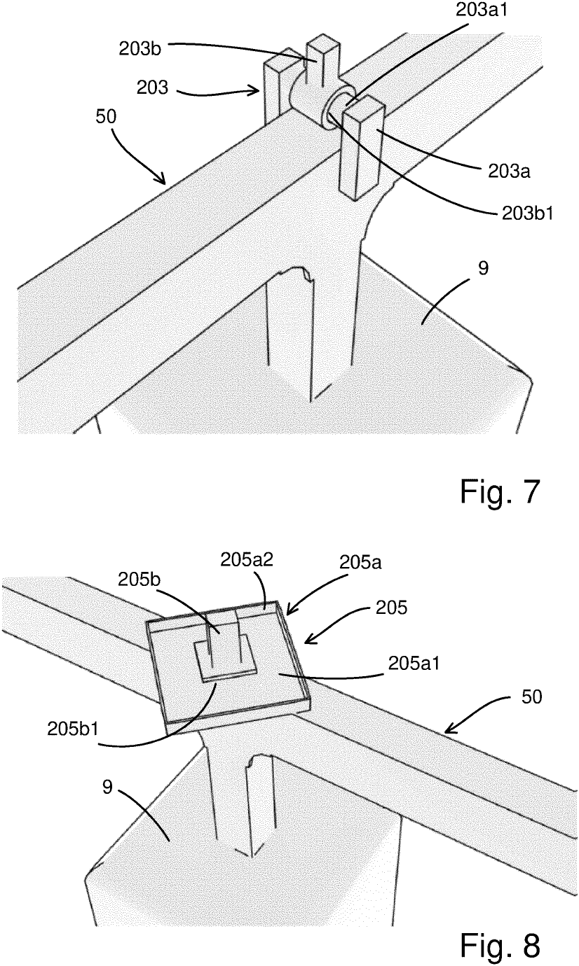

FIG. 7 is an enlarged perspective view showing a part of a flexible connection assembly that connects the floating structure with a carrying structure;

FIG. 8 is an enlarged perspective view showing a further part of a flexible connection assembly that connects the floating structure with a carrying structure;

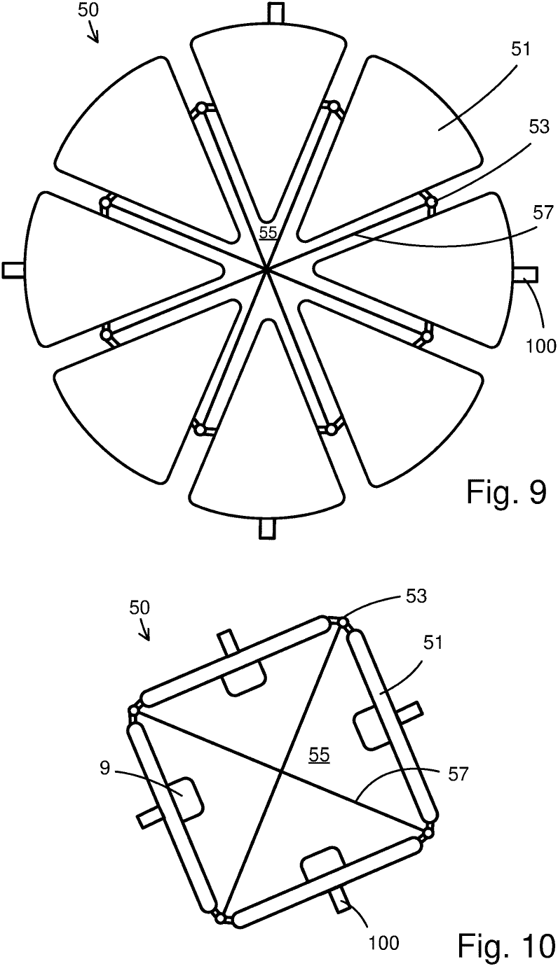

FIG. 9 is a top view of an alternative design of the floating structure;

FIG. 10 is a top view of another alternative design of the floating structure;

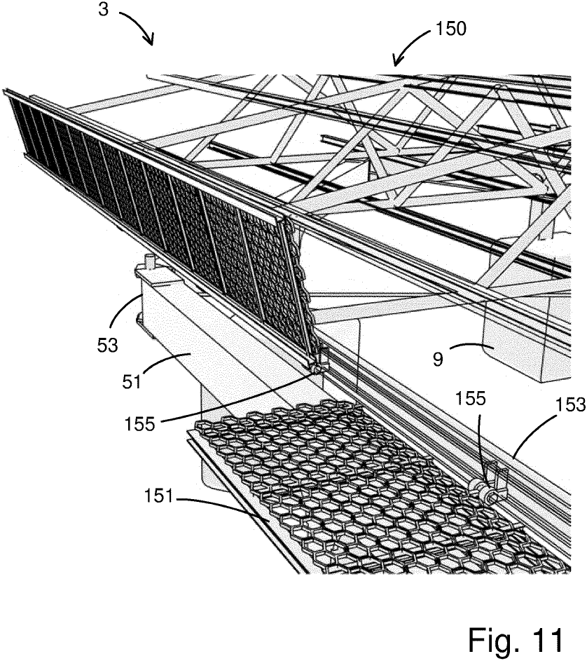

FIG. 11 is a perspective view showing a pivoting walkway being a part of the carrying structure;

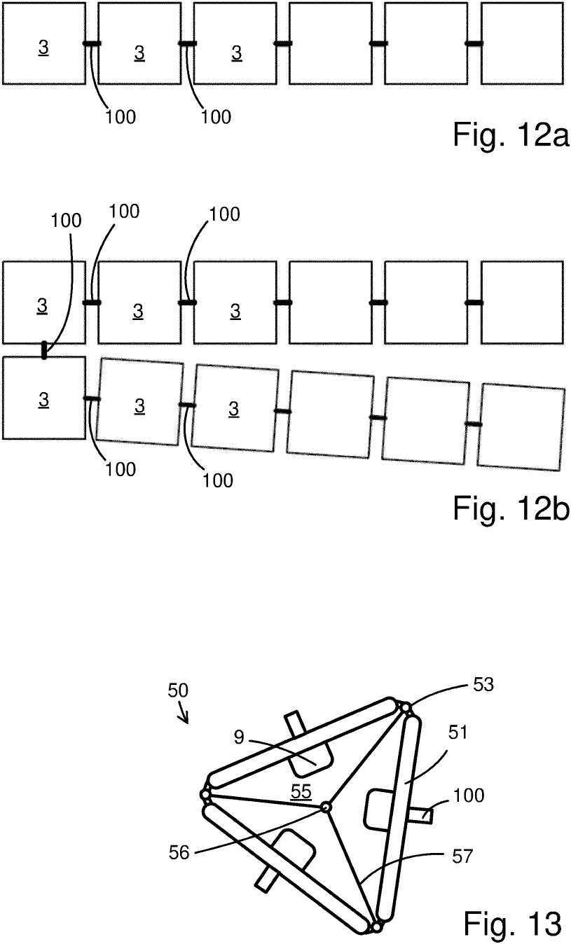

FIG. 12a is a principle top view showing a row of floating carrier modules;

FIG. 12b is a principle top view showing connection of to two adjacent rows of carrier modules;

FIG. 13 is a top view of yet another design for the floating structure;

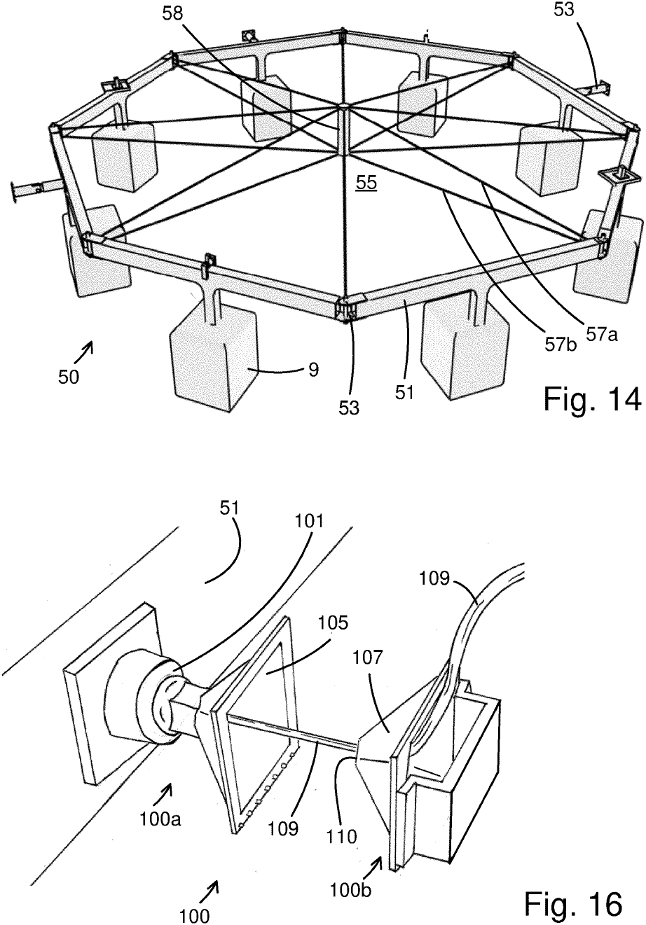

FIG. 14 is a perspective view of another embodiment of the floating structure;

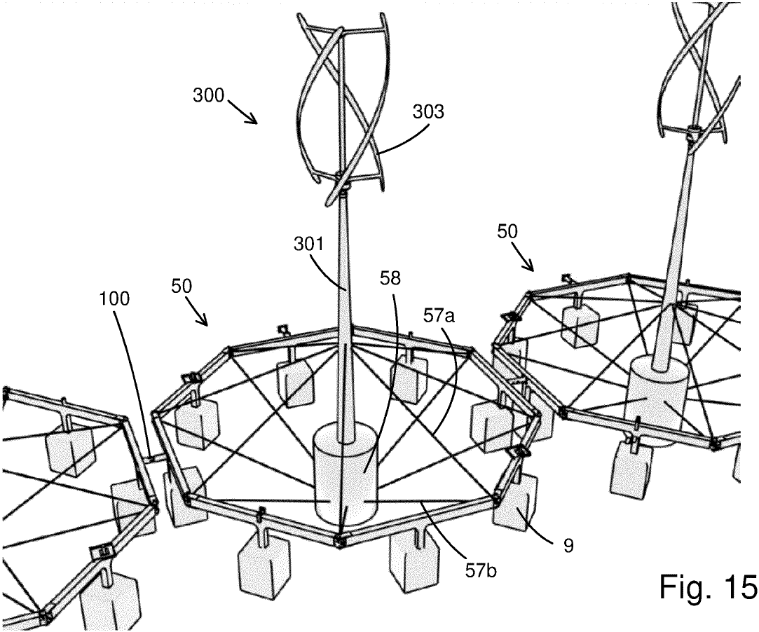

FIG. 15 is a perspective view of an alternative use of the floating structure, carrying a wind turbine; and

FIG. 16 is a perspective principle view of a flexible module link configured for connecting adjacent floating structures.

FIG. 1 shows a floating solar power plant 1 according to the present invention. It comprises a plurality of floating carrier modules 3, which each are attached to adjacent carrier modules 3 with a connection assembly. The power plant 1 shown in FIG. 1 has four carrier modules 3. However, it will be appreciated that in a more realistic embodiment, there may be several more carrier modules 3.

FIG. 2 depicts the solar power plant 1 from above, while floating on the sea surface. The floating carrier modules 3 are interconnected with flexible module links 100. Since the connections between adjacent carrier modules 3 are flexible, the carrier modules 3 can follow the motion of a wave.

In the shown embodiment, each carrier module 3 is provided with 66 photovoltaic (PV) modules 5 for generation of electric power.

FIG. 3 depicts a perspective view of one carrier module 3. The carrier module 3 is shown without the PV modules 5 for illustrational purpose.

The carrier module 3 comprises a floating structure 50 that comprises a plurality of buoyancy elements 9. Two purposes of the floating structure 50 is to make the solar power plant 1 afloat and to connect to adjacent floating structures 50, by means of the flexible module links 100.

Arranged on the floating structure 50 is a carrying structure 150. The carrying structure 150 is configured to receive the plurality of PV modules 5. In the shown embodiment, the carrying structure 150 is a rigid framework.

Reference is now made to FIG. 4 and FIG. 5, which illustrate a floating structure 50. The floating structure 50 comprises a plurality of interlinked rigid elements 51. The rigid elements 51 are connected to adjacent rigid elements 51 with flexible joints 53. As shown in FIG. 4 and in FIG. 5, the rigid elements 51 together encloses a central area 55.

In the shown example, the rigid elements 51 are in the form of straight beams forming a polygonal shape. In the shown embodiment there are eight rigid elements 51 that together make an octagon.

To maintain a shown form of the rigid elements 51, wherein they enclose a central area 55, resilient elongated members 57 extend across the central area 55, connecting rigid elements 51. In the shown example, the resilient elongated members 57 are connected at the flexible joints 53.

As will now be understood, the resilient elongated members 57 retain the shape of the rigid elements 51. However, since the resilient elongated members 57 exhibit flexibility, the overall shape of the interconnected rigid elements 51 can be somewhat changed when exposed to forces.

When several floating structures 50 are connected together, floating on water, and when exposed to waves, currents and wind (environmental forces), the shapes of the floating structures 50 will vary due to the force from the waves. Hence, while the flexible module links 100 allow different angles and mutual rotation of adjacent floating structures 50, the floating structures 50 will account for compressive and tensile forces.

In some embodiments, the resilient elongated members 57 can be fiber ropes. In other embodiments, the resilient elongated members 57 can be resilient struts.

By taking up compression and tensile forces in the floating structure 50 instead of in the flexible module link 100, one will have significantly longer distance available for a compression or extension. For instance, while a spring element in a flexible joint that connects adjacent floating modules may have only 50 - 30 cm available, the resilient elongated members 57 can be for instance between 7 and 25 meters long. With such lengths, materials that are normally not considered as resilient, may give enough resilience to take up the compressive and tensile forces.

For instance, in an embodiment where the resilient elongated members 57 are made of fiber ropes, and wherein the ropes are 10 meters long, an extension of the rope of 1 % will result in an extension of 10 cm. In other words, the distance between opposite rigid elements 51 will increase by 10 cm. When several floating structures 50 are interconnected as part of a floating solar power plant 1 according to the invention, this overall resilience or deformability will suffice for accounting for considerable wave sizes.

To ensure some rigidness in the floating structure 50, the resilient elongated members 57, such as fiber ropes, can be pre-tensioned.

FIG. 6 depicts an end portion of a resilient elongated member 57, in the form of a fiber rope. Also shown is the interface between two adjacent rigid elements 51 at the flexible joint 53. In this embodiment, the flexible joint 53 comprises a hinge bolt 59 that extends through apertures in beam connection flanges 61. A rope sheave 63 is attached to the hinge bolt 59 for connection to the fiber rope.

Contrary to the floating structure 50, the carrying structure 150 is rigid. Consequently, the connection between the floating structure 50 and the carrying structure 150 must allow the floating structure 50 to change its shape while the carrying structure 150 does not. To comply with this need, the floating carrier module 3 comprises a flexible connection assembly 200, by means of which the floating structure 50 and the carrying structure 150 are connected.

Referring to FIG. 5, the flexible connection assembly 200 comprises a rigid connection 201, a sliding connection 203, and two support connections 205.

The rigid connection 201 provides a rigid connection between one rigid element 51 and the carrying structure 150. Thus, any cabling between the carrying structure 150 and the floating structure 50 can advantageously be located at the location of the rigid connection 201.

FIG. 7 depicts the sliding connection 203 with an enlarged perspective view. The sliding connection 203 has a first part 203a, which is attached one rigid element 51 of the floating structure 50. Furthermore, the sliding connection 203 has a second part 203b that is attached to the carrying structure 150. As shown in FIG. 7, in this embodiment, the first part 203a comprises a rod 203a1 that extends through a bore 203b1 of the second part 203b. Thus, the second part 203b can slide back and forth on the rod 203a1 of the first part 203a. This movement will occur when forces are exerted on the floating structure 50 from waves and from adjacent, interconnected floating structures 50.

FIG. 8 depicts one support connection 205. Corresponding to the sliding connection 203, the support connection 205 also has a first part 205a connected to one rigid element 51 of the floating structure 50, and a second part 205b connected to the carrying structure 150. The second part 205b has a sliding face 205b1 that faces downwards and abuts a sliding plate 205a1 of the first part 205a. The second part 205b is thus configured to slide freely while being supported by the sliding plate 205a1 of the first part 205a. To avoid excessive movements, the sliding plate 205a1 is provided with a limiting edge 205a2 that encloses the sliding area of the sliding plate 205a1. In alternative embodiments, there may be no such limiting edge.

The rigid connection 201 and the sliding connection 203 retain the carrying structure 150 connected to the floating structure 50, so that it cannot be lifted off. Thus, in case of strong winds, the carrying structure 150 will be retained on its position on the floating structure 50.

The skilled reader will now appreciate that the shape of the floating structure 50 is able to change due to wave motions, while supporting and being connected to the rigid carrying structure 150 that carries the PV modules 5.

FIG. 9, FIG. 10, and FIG. 13 illustrate alternative embodiments of the floating structure 50. In the embodiment shown in FIG. 9, the floating structure 50 comprises eight rigid elements 51. The eight rigid elements 51 together form a substantially circular outer perimeter. As the skilled person will appreciate, the embodiment shown in FIG. 9 corresponds in many respects with the embodiment shown in FIG. 5, except that the shape of the rigid elements 51 is different.

In the embodiment shown in FIG. 10, there are only four rigid elements 51, linked together with four flexible joints 53. The opposite flexible joints 53 are connected with resilient elongated members 57.

In the embodiment shown in FIG. 13, there are only three rigid elements 51 and three flexible joints. The resilient elongated members 57 are connected at the central area 55, with a central connection piece 56.

FIG. 11 is a perspective view of a portion of one floating carrier module 3. The carrying structure 150 is provided with walkways 151. The walkways 151 facilitate movement of personnel on the floating carrier modules 3. They are connected to framework beams 153 with connection hinges 155, as shown in FIG. 11.

Due to the hinges, the walkways 151 can be tilted between a horizontal and a vertical position. As can be seen for instance in FIG. 2, when several floating carrier modules 3 are connected to form a floating solar power plant 1, much light is prevented from reaching the sea. At some locations, such as at shallow waters, one may want to allow light to reach into the sea. By tilting the walkways 151 to the vertical position, one will allow more light to reach past the floating solar power plant 1. This may be positive for marine life, such as marine plants.

As can be seen in FIG. 1 and in FIG. 3, the carrying structure 150 comprises two main carrying faces that have a mutual angle with respect to each other. This resembles the ridge of a house roof. As shown in FIG. 3, there is arranged an additional walkway 151a that extends below and parallel to the ridge. The additional walkway 151a provides access to the PV modules 5 from below.

FIG. 12a and FIG. 12b are schematic top views of a plurality of connected carrier modules 3 floating on the water. These drawings illustrate an advantageous method of assembling the carrier modules 3 into the floating solar power plant 1.

In FIG. 12a there are shown a plurality of carrier modules 3 that are interconnected to form a first row of carrier modules 3. The carrier modules 3 are connected with flexible module links 100. When two rows of carrier modules 3 are assembled, they are brought together as shown in FIG. 12b and connected. Advantageously, two carrier modules 3 arranged at corresponding ends of the first and second row of carrier modules 3 are connected first. Then, succeeding carrier modules 3 are connected so that ultimately, all the carrier modules of the first and second row connect to one carrier module 3 of the adjacent row.

When the first and second parallel rows of carrier modules 3 have been connected, a third row and a fourth row of carrier modules 3 is connected, and so forth. Finally, all the carrier modules 3 are connected to form the floating solar power plant 1. Due to the flexibility of the flexible module links 100 and the shape-changing capability of the floating structures 50, the floating solar power plant 1 can tolerate waves.

Reference is now made to FIG. 14, which depicts another alternative embodiment of the floating structure 50. In this embodiment, there is arranged a vertical member 58 at the central area 55, to which upper resilient elongated members 57a and lower resilient elongated members 57b connect. The upper and lower resilient elongated members 57a, 57b compare with the resilient elongated members 57 discussed earlier. However, as can be seen in FIG. 14, from the rigid elements 51, in this embodiment from the flexible joints 53, two resilient elongated members extend instead of one.

The upper and lower resilient elongated members 57a, 57b, connect to the vertical member 58 at an upper and a lower position, respectively. As shown, there is a vertical distance between the upper and lower positions. The connection of the upper and lower resilient elongated members 57a, 57b to the vertical member may contribute in retaining the planar shape of the interconnected rigid elements 51. Furthermore, they may enable support for a component arranged centrally, i.e. at the central area 55.

FIG. 15 does not relate to a floating solar power plant, but rather illustrates an alternative application of the floating structure 50. In this embodiment, the floating structure 50 supports a wind turbine assembly 300. The wind turbine assembly 300 comprises a wind turbine tower 301 carrying a wind turbine 303. A portion of the turbine tower 301 constitutes the vertical member 58, to which the upper and lower resilient elongated members 57a, 57b attach. In the shown embodiment several floating structures 50 are interconnected with flexible module links 100 to form a floating wind turbine plant.

FIG. 16 is a schematic, principle view of a flexible module link 100 that may be employed with floating solar power plant 1 according to the invention, and/or with the floating structures 50 as disclosed herein. The flexible module link 100 shown in FIG. 16 comprises a first module link part 100a and a second module link part 100b. When the connection has been made, the first module link part 100a is fixed to the second module link part 100b. The first module link part 100a is provided with a flexible joint 101, which may be a ball-and-socket joint.

Moreover, the flexible module link 100 comprises a guiding means. The guiding means comprises a first and second guide part 103a, 103b. The first guide part 103a comprises a funnel 105 for reception of the facing second guide part 103b that comprises a tapered part 107.

The flexible module link 100 further comprises a pull-in-line 109. The pull-in line 109 is fixed to one of the first and second module link parts 100a, 100b. In the shown embodiment, the pull-in line 109 is fixed to the first module link part 100a and extends through an aperture 110 at the apex of the tapered part 107. Thus, when connecting two floating structures 50, of which one is fixed to the first module link part 100a and the other is fixed to the second module link part 100b, the operator may pull the pull-in line 109 to mate the first and second module link parts 100a, 100b.

It will be understood that also a flexible connection assembly 100 without the guiding means and/or the flexible link 101 may comprise such a pull-in line 109.

1. A floating solar power plant comprising a floating carrier module, the floating carrier module comprising:
photovoltaic modules for electric power generation;
a floating structure provided with one or more buoyancy elements extending into the water,
wherein the floating structure comprises a flexible means providing a change of shape of the floating structure when exposed to external forces, as the floating structure comprises a plurality of interlinked rigid elements, wherein the rigid elements are linked together with flexible means comprising flexible joints to form a chain that encloses a center area.

2. The floating solar power plant according to claim 1, comprising:
a carrying structure carrying the photovoltaic modules; and
a flexible connection assembly connecting the carrying structure and the floating structure.

3. The floating solar power plant according to claim 1, comprising a plurality of floating carrier modules that are interconnected with flexible module links.

4. The floating solar power plant according to claim 1, comprising resilient elongated members extending across the center area between opposite rigid elements.

5. The floating solar power plant according to claim 4, wherein the resilient elongated members extend between opposite flexible joints.

6. The floating solar power plant according to claim 4, wherein the rigid elements are straight beams connected with their end portions to the flexible joints.

7. The floating solar power plant according to claim 4, wherein the resilient elongated members are made of fiber ropes, steel wires, bars, or rods.

8. The floating solar power plant according to claim 2, wherein the flexible connection assembly comprises three connections of which at least two connections comprise a first part and a second part,
wherein the first part is configured to move with respect to the second part of the respective connection.

9. The floating solar power plant according to claim 2, wherein the carrying structure comprises a walkway located below at least some of the photovoltaic modules.

10. The floating solar power plant according to claim 2, wherein the carrying structure comprises a walkway at a perimeter of the carrying structure, wherein the walkway is configured to pivot between:
a horizontal orientation, wherein the walkway exhibits a substantially horizontal upper face for support of personnel, and wherein the walkway is directly facing the water surface below it; and
a non-horizontal orientation, wherein the walkway is pivoted away from the horizontal mode, leaving the water surface uncovered.

11. The floating solar power plant according to claim 4, wherein the resilient elongated members comprise upper resilient elongated members and lower resilient elongated members, which extend between the interlinked rigid elements and an upper and lower position, respectively, of a vertical member located within the central area.

12. The floating solar power plant according to claim 3, wherein the flexible module link comprises a first module link part, a second module link part configured to be connected to the first module link part, a pull-in line fixed to one of the first and second module link parts, wherein the pull-in line extends through an aperture of the other of the first and second module link parts.

13. A method of installing a floating solar power plant on a sea surface, wherein the power plant comprises a plurality of carrier modules configured to carry photovoltaic modules, wherein the method comprises the following steps:
a) while floating on the sea surface, connecting a plurality of carrier modules into a first row of carrier modules, by means of flexible module links between the adjacent carrier modules;
b) connecting a plurality of further carrier modules into a second row of carrier modules, by means of flexible module links between adjacent carrier modules;
c) moving, on the sea surface, the first row of carrier modules towards the second row of carrier modules; and
d) connecting, by means of flexible module links, one carrier module of the first row to one carrier module of the second row; and
e) connecting further adjacent carrier modules of the first and second row to each other to form two connected and parallel first and second rows; and
f) connecting additional rows of carrier modules to one of the previously connected rows of carrier modules.
